(19) United States
(12) Patent Application Publication
(10) Pub. No.: US 2001/0042017 A1
(43) Pub. Date: Nov. 15, 2001

(54) Advertisement distribution system

(76) Inventor: Yukihiro Matsukawa, Nagoya-shi (JP)

Correspondence Address: DAVIS & BUJOLD, P.L.L.C., 500 NORTH COMMERCIAL STREET, FOURTH FLOOR, MANCHESTER, NH, 03101, US

(21) Appl. No.: 09/851,518

(22) Filed: May 8, 2001

(30) Foreign Application Priority Data
May 10, 2000 (JP) 2000-137363
Oct. 18, 2000 (JP) 2000-318172
Apr. 13, 2001 (JP) 2001-115325

(51) Int. Cl. G06F 17/60

(52) U.S. Cl. 705/14

(57) ABSTRACT

A system for distributing advertising information with digital contents is provided. The advertisement distribution system is beneficial to users, advertisers and owners of the digital contents and helps to vitalize the information and communication industry. Distribution data transmitted to a user terminal from a service center are constituted as music data formed by combining an advertising message with a specific musical piece selected by the company for advertisement. Specifically the advertisement message partly overlays the first part and the last part of the musical piece. Thereby, when the music data are played, the advertising message is also played with the musical piece.

### BACKGROUND OF THE INVENTION

i) Technical Field of the Invention

This invention relates to a system which distributes digital contents with advertising data such as company information, etc.

ii) Description of the Related Art

In recent years, pay distribution systems have been known which distribute digital data (hereinafter, referred to as “digital contents”) such as musical pieces, moving pictures, still pictures and the like via the Internet. However, since users who utilize such systems are required to pay a certain fee to obtain the digital data, they are likely to hesitate about a download. Therefore, it is desirable that the download fee should be as cheap as possible.

For example, if there is a distribution system which functions also as an advertising system and in which a sponsor company of a performer (musical piece) can invest their money to be advertised, the musical piece can be offered to users at a low price and it is beneficial for both the users who wish to obtain the musical piece and the company itself. Furthermore, in this case, since the users may afford to obtain additional musical pieces such as of which performers are not yet popular (so-called indies), a synergistic effect can be expected that also the performers can get a number of chances to publish their works.

Also, it is an internationally common perception to develop a music distribution system by which musical pieces that satisfies listeners can be downloaded for free without infringing on copyrights with respect to the musical pieces. However, a business project for developing such music distribution systems has never known.

### SUMMARY OF THE INVENTION

Wherefore, one object of the present invention is, in a system for distributing advertising information together with digital contents, etc., to provide an advertisement distribution system which is beneficial to users, advertisers and owners of the digital contents, and thus to vitalize the information and communication industry.

In order to attain the above and other objects, the advertisement distribution system of the present invention comprises a storage means which stores both or one of music data including a specific musical piece combined with an advertising message, and image data including a specific image combined with at least one of an advertising image and advertising message as distribution data in a plurality of types.

The “specific musical piece” herein described is a musical piece of currently famous artists and various performers such as so-called indies whose sponsor is a company and the like. Similarly, the “specific image” herein described is an image of popular movies and various films such as promotional films of which sponsor is a company and the like. The musical piece and image can be held beforehand in the advertisement distribution system, or can be acquired from other music distribution sites currently existing on the Internet.

Such specific musical pieces or images (hereinafter, referred to as “musical piece or the like”) are combined with an advertising message or advertising image of a company which desires to be advertised in exchange of a distribution fee, for example. Therefore, when the music data are played, the advertising message is also played along with the musical piece, and when the image is played, the advertising message and/or advertising image is also played along with the image.

Furthermore, in an operation of the present advertisement distribution system, a transmission means transmits a distribution data type stored in the storage means to a user terminal via a predetermined communication line such as a wide area network. The transmission means extracts distribution data selected by a user from the storage means at the request inputted from the user terminal via the communication line, and transmits the distribution data to the user terminal.

Therefore, the user who downloads the music data or image data is forced to listen or watch the automatically played advertising message or advertising image when the musical piece or image is played.

Accordingly, the company can attempt to improve its image by attaching the company information to so sophisticated a musical piece or the like that it sells ten thousands even though it is charged, which cannot be achieved by printing the company information to calendars, notebooks, fans, towels, etc. Moreover, a distribution price of the music data or image data can be lowered in the same manner as in the case of the aforementioned products. This is possible because the distribution goods are simply digital data which do not constitute a physical shape.

Moreover, since the user downloads the musical piece or the like to listen to it repeatedly, when the user listens to the musical piece at a different place, the company information is spontaneously recalled to the user. This is because the company image is imprinted on the user's memory together with the musical piece. In general, a commercial message (CM) song has the same effect as the above. However, according to the advertisement distribution system of the present invention, it is not necessary to play the CM song on TV and radio, and even more the similar effect can be achieved at an extremely low cost.

On the other hand, performers are very attracted to a CM song because the CM song has possibility to make them famous. Because the CM song is heard for free by ordinary people over and over and memorized in relation to the product, there are great many chances that the song is remembered. Therefore, there exist a number of performers who desire to play a CM song if there is a chance, and in fact the performer who plays a CM song becomes famous. According to the present advertisement distribution system, performers who are not yet famous can be given a lot of chances to become famous. And users of the advertisement distribution system can have much opportunity to listen to a musical piece or the like of new performers.

However, both to the user and the performer, the musical piece or the like itself is valuable. So if an advertising message or advertising image is conspicuous, an unfavorable phenomenon may occur.

Therefore, the second aspect of the present invention provides music data which include an advertising message disposed at least one of just before and after a musical piece.

For example, the company information are preferably inserted before a starting part or after an ending part of the musical piece or the like for about 5 seconds, together with an introduction of the performer and the musical piece or the like. In this case, the sound volume of the information is preferably set as low as possible.

Similarly, the image data are preferably constituted such that the advertising message or advertising image can be disposed at least one of in front of and behind the image.

Moreover, the advertising message and advertising image can overlap the musical piece or the like instead of being disposed before and after the musical piece or the like. This can be realized when the music data or image data are digitized, as set forth in the third aspect of the present invention.

Specifically, in t his case, the advertising message overlaps at least one of the first part and last part of the musical piece. Or, the advertising message or advertising image overlaps at least one of the first part and last part of the image.

However, there may be users who cannot bear the fact that the advertising message or advertising image appears every time they wish to play the musical piece or the like. If the user wishes to listen to the especially favorable musical piece, so much the worse.

Therefore, in the fourth aspect of the present invention, the advertising message or advertising image can be separated from the musical piece or image, respectively.

The system being constituted as such, the users can listen only to the musical piece or the like which they desire to listen repeatedly without being offended after the separation of the advertising message or advertising image.

On the other hand, it is considered that the advertising message or advertising image is listened to or watched several times (at least once) and perceived by the users before separated. Furthermore, even if the advertising message or advertising image can be separated, it is practically difficult for those who do not have a certain level of knowledge in data processing to perform such separation. Therefore, also for the company, a certain effect of the advertisement is likely to be achieved.

However, when the advertisement distribution system of the present invention becomes well-known in the future and it is feared that the user may separate the advertising message or advertising image hurriedly after obtaining the data of a musical piece or the like.

Therefore, in the fifth aspect of the present invention, after the music data or image data are listened to or watched predetermined times, the advertising message or advertising image is automatically separated from the musical piece or image.

Specifically, as explained later in the embodiment, an executable file for the separation may be also attached to the data of a musical piece or the like when the data are transmitted to the user terminal, for example.

Here, the data are favorably constituted such that even those who have knowledge in data processing cannot separate the advertising message till the advertising message or advertising image is listened to or watched predetermined times.

Constituted as such, the advertising message or advertising image is always listened to or watched the predetermined times and the company is assured of the advertising effect at a certain level.

Furthermore, as constituted as above, even those who have no knowledge in data processing can certainly obtain the data including only the musical piece or the like they wish to listen to or watch, because the advertising message or advertising image is automatically separated after the predetermined times of listening or watching. Moreover, if the user can obtain the musical piece in its perfect form at the end for free, the user may not try to do acts that can be illegal or that may infringe on a right of the favorable musician. Accordingly, use of the present advertisement distribution system is promoted, and as a result, the advertising effect of the company is rapidly heightened.

Thus, by “separating a company's advertisement attached to a musical piece or the like after predetermined times of replay”, a business model which satisfies the needs of an owner of the musical piece or the like, user, advertised company and music related company is completed.

Furthermore, the music data or image data may be obtained by others by means of a transfer or copy after they are transmitted to a user terminal In this case, if no measures are taken, the others can obtain the musical piece without the advertising message or advertising image for free. Then, it is feared that the company cannot obtain compensation for payment of the distribution fee.

Therefore, in the sixth aspect of the present invention, when the aforementioned musical data are transferred or copied from the user terminal to other terminals, then the transferred data are preferably set to include the advertising message combined with the musical piece or be unplayable. Also, when the above image data are transferred or copied from the user terminal to other terminals, the transferred data are preferably set to include at least one of the advertising message and advertising image combined with the original image, or be unplayable.

The constitution as such can be realized by coding in the aforementioned executable file a feature of transferring the separately prepared data with the advertising message, when the data of above musical piece or the like are to be transferred or copied to terminals other than the user terminal to which the data are downloaded.

In that case, by transmitting the executable file for the separation together with the data of the musical piece or the like to a destination terminal, it is possible that the same separation process as above described is performed after the predetermined times of listening or watching.

Furthermore, if the company or administrator of the present advertisement distribution system cannot grasp at all the fact that the data are transferred or copied as such, it is impossible to evaluate the advertising effect (distribution effect). Also, there is a fear that the owner of the musical piece or the like may suffer disadvantage.

Therefore, in the seventh aspect of the present invention, when the music data or image data are transferred or copied from the user terminal to other terminals, the music data or image data are locked so that they cannot be played, respectively. By entering a predetermined password transmitted from the advertisement distribution system on predetermined conditions (for example, upon request from the user terminal from and to which the data are transferred), the data can be unlocked.

It is also possible to constitute the system such that predetermined management data are added to part of the file information of the data of a musical piece or the like, for example, and by checking the management data, the number of copies made, times of listening, etc. are managed. It is further possible to constitute the system such that the file storage area and the like are all recorded to the data of a musical piece or the like which are downloaded to a private player, and if the data are not located in the recorded area, the data cannot be played.

According to the constitution as above, the administrator of the advertisement distribution system can grasp the number of transfers or copies made by counting the number of requests for the password and also obtain the name of the advertised company, information on the area where the data are transferred. Moreover, it becomes possible to calculate a fair fee for the owner of the musical piece so that offers to provide musical pieces can be accepted by the owner. Furthermore, the company can recognize the advertising effect with an actual numerical value.

Now, email services via a wide area network such as the Internet are used widely as advertising media. In such a email service, some kind of privilege is generally given to users, and upon agreement of the users, emails including company information or the company information themselves are transmitted to the users.

However, to be given the privilege, the users have to satisfy the needs of the sponsor company with respect to company advertisement, product advertisement, or marketing research. A form of the service is a membership system and upon becoming a member or each time receiving emails, the users have to answer lots of items related to personal information or a questionnaire. Depending on the situation, the users are forced to disclose their privacy.

Moreover, once the users give permission to the transmission of advertising emails, they must receive such emails constantly, and a trouble may occur in receiving of personal mails.

Therefore, in the eighth aspect of the present invention, the advertisement distribution system comprises a detection means for detecting positional information of a portable terminal as a user terminal which the user keeps. Specifically, the detection means uses a positional information service utilizing a GPS (Global Positioning System) or a PHS (Personal Handyphone System) cell station to detect the positional information of the portable terminal as explained in the following embodiment.

Then, the transmission means transmits a type of distribution data and a way to obtain the distribution data only to the specific terminal detected by the detection means. And then, the transmission means transmits the above distribution data, on predetermined conditions, to the user who requests to obtain the data from the portable terminal as directed.

Such constitution makes possible user participatory email distribution in which the user has to be a registered member beforehand. In this case, if the user wishes to participate, the user has to be at the specific place directed by an email and the like in advance. However, the detection means specifies the terminal the data to be transmitted to according to the positional information. Therefore, even if the user's detailed information are unknown, the user's telephone number and email address can be enough to transmit the data. Such a advertisement distribution system can be adopted to various scenes such as for collecting customers to a department store, an event, or a specific area to boost the local economy.

### BRIEF DESCRIPTION OF THE DRAWING FIGURES

The invention will now be described, by way of example, with reference to the accompanying drawings, in which:

FIG. 1 is a block diagram showing an overall constitution of an advertisement distribution system according to the first embodiment of the present invention;

FIGS. 2A and 2B are explanatory diagrams showing a constitution of music data to be distributed by the advertisement distribution system of the first embodiment;

FIG. 3 is an explanatory diagram showing an embodied implementation of the advertisement distribution system of the first embodiment;

FIG. 4 is an explanatory diagram showing an embodied implementation of the advertisement distribution system of the first embodiment;

FIG. 5 is an explanatory diagram showing an embodied implementation of the advertisement distribution system of the first embodiment; and

FIG. 7 is an explanatory diagram showing an embodied implementation of the advertisement distribution system of the second embodiment.

### DETAILED DESCRIPTION OF THE PREFERRED EMBODIMENT

First Embodiment

An advertisement distribution system according to the present embodiment is used by a user who wishes to obtain a favorite musical piece and a company (advertiser) who desires to be advertised via a music distribution company (service center) on the Internet.

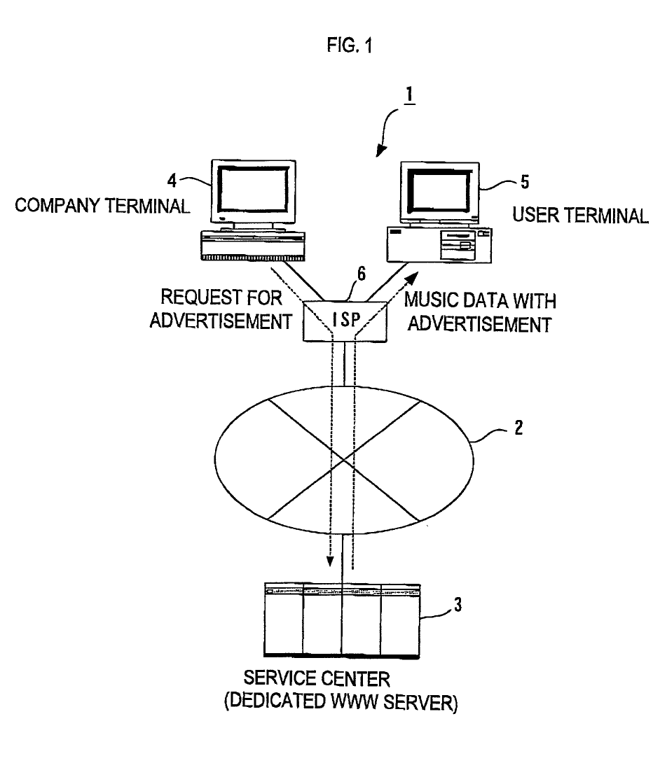

As shown in FIG. 1, an advertisement distribution system 1 is constituted as a system which provides music data to a terminal of a registered customer from a service center 3 connected to the Internet 2 as a wide area network. Although the advertisement distribution system 1 can be used by a plurality of members, the present embodiment shows a case expediently where the system is used by a company which requests the service center 3 to place an advertisement of their own company and by a general user. Accordingly, in FIG. 1, a company terminal 4 of the company and a user terminal 5 of the user are connected to the Internet 2 via an ISP (Internet Service Provider) 6.

Also in FIG. 1, only the single ISP 6 is illustrated as a matter of explanatory convenience. Needless to say, however, each terminal can be connected to the Internet 2 via different ISPs.

The service center 3 owns a dedicated WWW (World Wide Web) server, and provides information at the request from the company terminal 4 or the user terminal 5 connected to the Internet 2 via the ISP 6 as sell as establishes predetermined communication with the company terminal 4 or user terminal 5.

On the other hand, in the company terminal 4 and the user terminal 5, there are provided an input device such as a keyboard, mouse, etc. and a display device to display information provided from the WWW server of the service center 3. Accordingly, the user of the advertisement distribution system 1 can input necessary data using the input device by following the instructions displayed on the display device to carry out a predetermined procedure and to obtain a desired product, service and other information selectively. Means of communications connecting the company terminal 4 and the user terminal 5 with the ISP 6 can be a communication device for telephone such as a modem, terminal adapter or the like for connecting to the ISP 6 via a general telephone network, or a communication device for a wireless telephone such as a cellular phone, PHS, and so on.

In a database of the service center 3, data of a musical piece of currently famous artists and various performers such as indies who have a sponsor company, and distribution data prepared at the request of the sponsor company are stored in a large amount.

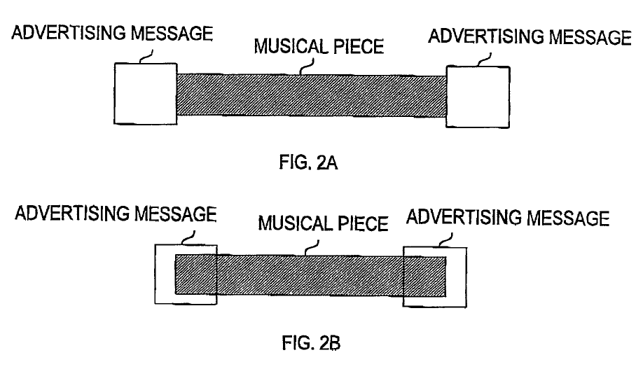

The distribution data are constituted as music data created by combining an advertising message with a specific musical piece selected by the sponsor company for advertisement of the company. Specifically, the music data are digitized, and as shown in FIG. 2A, they are constituted such that the advertising message is deposited just before and after the musical piece, or as shown in FIG. 2B, they are constituted such that the advertising message partially overlaps the very first part and the very last part of the musical piece. Accordingly, when the music data are played, the advertising message is also played along with the musical piece.

Additionally, this advertising message is set to prolong for about 5 seconds so that the listener of the musical piece is not bothered. Furthermore, because the music data are digitized, the musical piece and the advertising message can be separated by a predetermined process which is explained later.

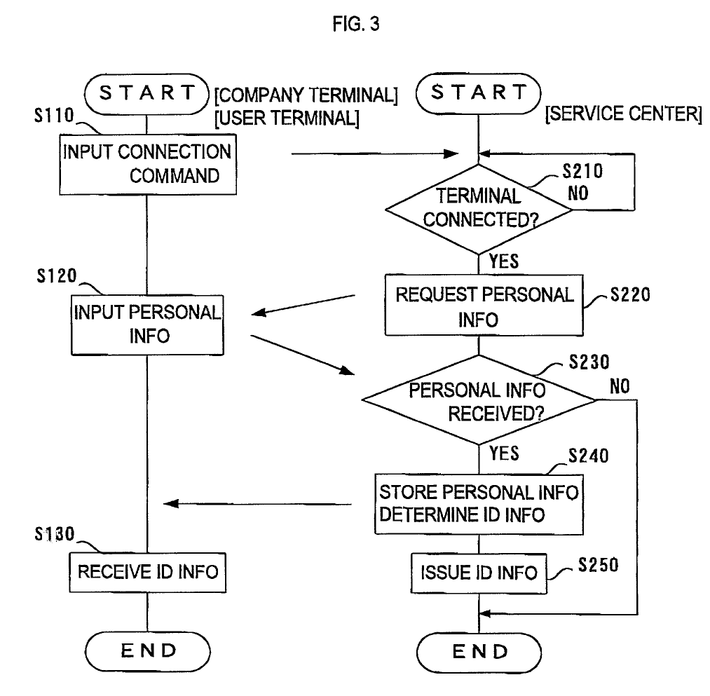

Now, an actual operating procedure of the advertisement distribution system 1 is explained according to flow charts shown in FIGS. 3-5.

Firstly, an explanation is given on a registration process performed by a company and a general user so that they can utilize the advertisement distribution system 1, according to the flow chart shown in FIG. 3.

In order to utilize the advertisement distribution system 1, the company and the general user connect the company terminal 4 or the user terminal 5 to the Internet 2 via the ISP 6, and input a command requesting a connection to the service center 3 (S110).

The service center 3 determines whether there is a connection from the company terminal 4 or the user terminal 5 (S210) When there is the connection (if S210 is YES), the service center 3 requests personal information (S220). The personal. information include attributive information such as a name, business category, operation type, address, etc. if the applicant is a company, and a name, telephone number, address, job classification, email address, etc. if the applicant is a general user. The personal information are inputted by a person in charge of the company or a general user using a predetermined input device according to a selection screen displayed on the terminal display device.

Here, when there is no input of the personal information from the company terminal 4 or the user terminal 5, and no receipt of the information is confirmed (if S230 is NO), the service center 3 determines that the company or the general user has no wish to be registered as a member, and quits the registration process.

On the other hand, when the personal information are inputted from the company terminal 4 or the user terminal 5 (S120) and the receipt of the information is confirmed at the service center 3 (if S230 is YES), the service center 3 stores the personal information in its own database. Furthermore, it determines identification information (such as identification number, password or the like) to be used for authentication when the company or the general user utilizes the advertisement distribution system 1 (S240).

Then, the service center 3 issues the identification information to the company terminal 4 or the user terminal 5 (S250), and the. company or the general user receives the identification information (S130).

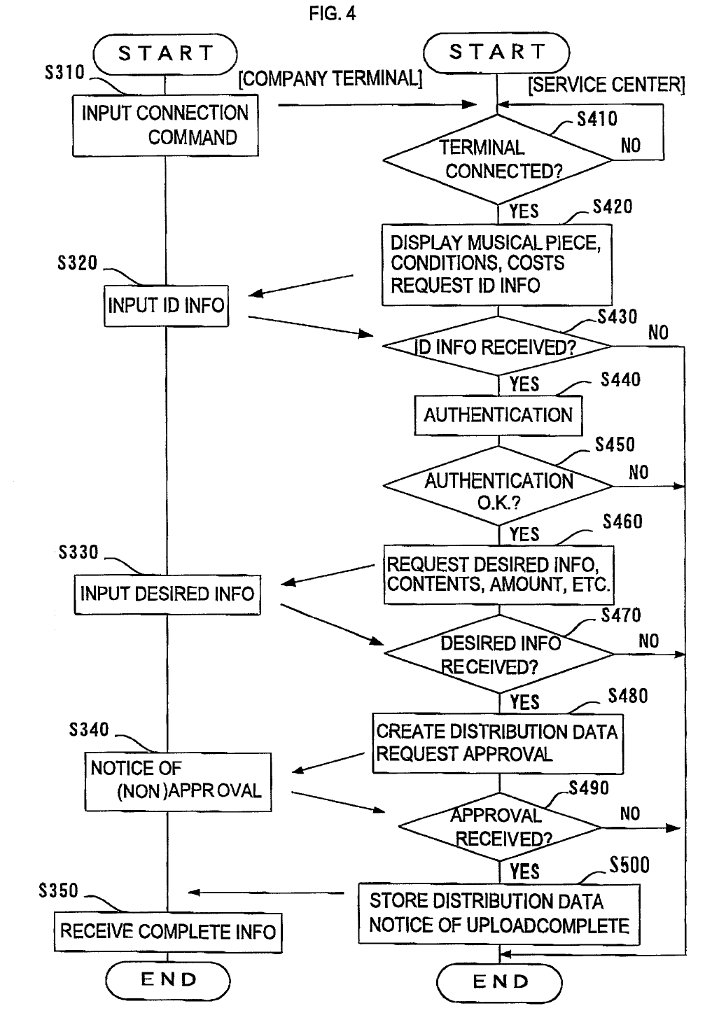

Secondly, a registration process of distribution data (music data) in the advertisement distribution system 1 is explained according to a flow chart shown in FIG. 4.

On the site of the service center 3 provided on the Internet 2, a list of musical pieces which can be distributed in combination with a advertising message as company information and the needed costs are posted. A company (advertiser) which wishes to distribute its own company information connects the company terminal 4 to the Internet 2 via the. ISP 6 and inputs a command requesting a connection to the service center 3 (S310).

When the service center 3 determines that there is the connection (if S410 is YES), it presents the list of musical pieces which can be distributed in combination with an advertising message, the conditions and costs while requesting an input of the aforementioned identification information (S420). At this time, when there is no input of the identification information from the company terminal 4 and no receipt of the information is confirmed (if S430 is NO), the service center 3 determines that the company is not a member of the system or that the company has no wish to utilize the system, and ends the process.

On the other hand, when the identification information is inputted from the company terminal 4 (S320) and the service center 3 confirms the receipt of the information (if S430 is YES), the service center 3 conducts an authentication process using the inputted identification information (S440). At this time, when the authentication is not performed (if S450 is NO), the process is ended.

When the authentication is performed normally in S450 (if S450 is YES), then the service center 3 requests the contents of the advertisement the company wishes to be transmitted, the name of a requested musical piece, requested amount of distribution (number of distribution), etc (S460). At this time, when there is no input of the requested information and no receipt of the information is confirmed (if S470 is NO), the process is ended.

On the other hand, when the requested information is inputted from the company terminal 4 (S330) and receipt of the information is confirmed (if S470 is YES), the service center 3 creates distribution data according to the requested information, that is, executes the aforementioned combining process. Then, the service center 3 transmits the created distribution data to the company terminal 4, and asks for approval of providing general users with the distribution data (S480).

When it is determined that the approval is made by a notice of approval (if S490 is YES) from the company terminal 4, the distribution data are uploaded to the site for general users and a notice of completion is transmitted to the company terminal 4 (S500). The company receives the notice of completion (S350).

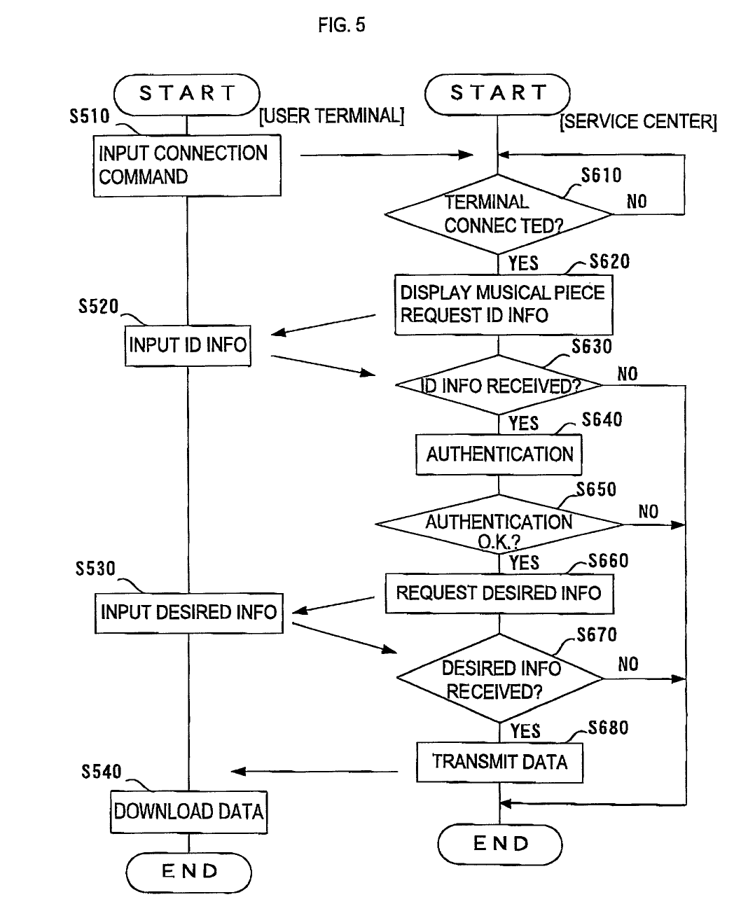

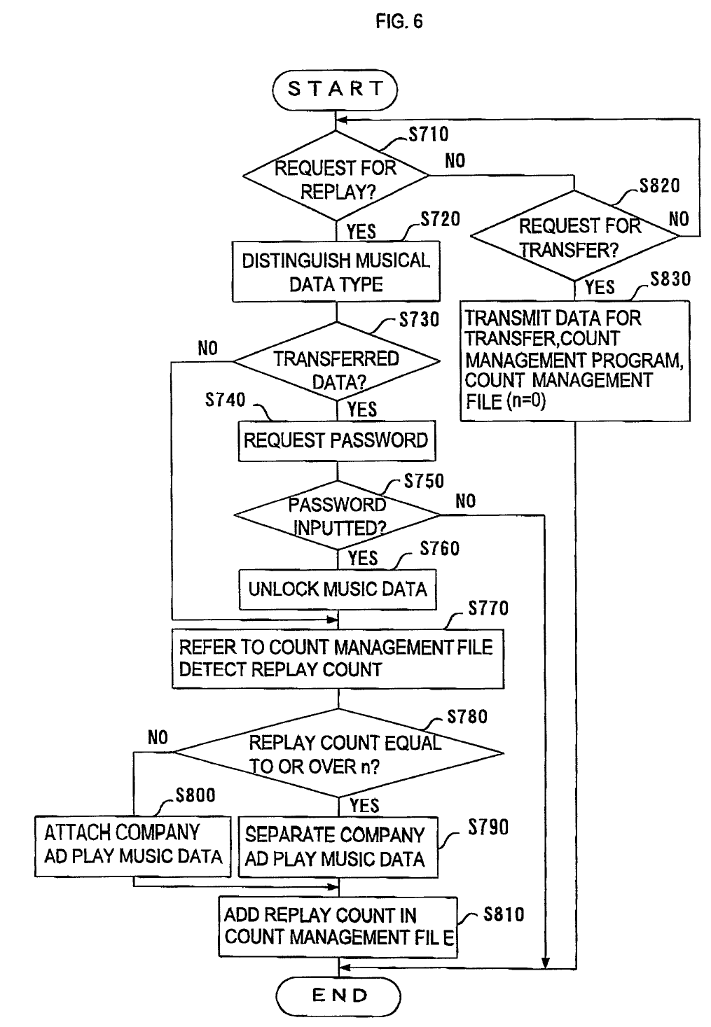

Thirdly, a distribution process performed by the advertisement distribution system 1 when a general user acquires music data (distribution data) is explained according to a flow chart shown in FIG. 5.

On the site of the service center 3, a list of the distribution data (music data) uploaded in the above manner is posted to the general users.

The general user who wishes to acquire the music data connects the user terminal 5 to the Internet 2 via the ISP 6, and inputs a command requesting a connection to the service center 3 (S510).

When the service center 3 determines that there is the connection (if S610 is YES), it presents the list of distributable music pieces while requesting an input of the aforementioned identification information (S620). At this time, when there is no input of the identification information from the user terminal 5 and no receipt of the information is confirmed (if S630 is NO), the service center 3 determines that the general user is not a member of the system or the user has no wish to utilize the system, and ends the process.

On the other hand, when the identification information is inputted from the user terminal 5 (S520) and the service center 3 confirms receipt of the information (if S630 is YES), the service center 3 conducts the authentication process using the identification information (S640). At this time, if the authentication is not performed (if S650 is NO), the process is ended.

When the authentication is performed normally in S650 (if S650 is YES), then the general user is requested to input the name of the selected musical piece to be transmitted (S660). At this time, when there is no input of the requested information and no receipt of the information is confirmed (if S670 is NO), the process is ended.

On the other hand, when the requested information is inputted from the user terminal 5 (S530) and receipt of the information is confirmed (if S670 is YES), the service center 3 extracts the corresponding distribution data by searching its own database and transmits the data to the user terminal 5 (S680). At this time, “a count management file” and “a count management program” to be used for a separation process of the advertising message which is explained later are also transmitted. The general user can download the distribution data (S540).

The music data (distribution data) obtained as such by the general user include an advertising message as described in the above. The above-mentioned count management program is executed every time the general user listens to the musical piece (i.e. advertising message). Thus, when the user listens to the musical piece n times (i.e 5 times in the present embodiment), the advertising message is automatically separated from the musical piece. Therefore, the general user can listen to the musical piece independently thereafter any number of times. The number n of listening can be set freely by the service center 3 considering the company's request, etc.

Lastly, a process executed by the count management program is explained according to a flow chart shown in FIG. 6. The count management program is a very small program, the size of which is about tens of bites, for example. The program resides in a predetermined area of the user terminal 5 and is executed automatically every time the user plays the above music data.

When the user requests the musical piece to be played by a predetermined operation (if S710 is YES), the type of the music data is firstly distinguished (S720). Here, the music data to be played are distinguished between the data downloaded properly from the service center 3 as above described and the data transferred by another user.

When it is determined that the data are not the transferred data (that is, the data are the properly downloaded music data) (if S730 is NO), a count number recorded on the count management file is referred to and a replay count (number of times the musical piece is listened to) is detected (S770).

Then, it is determined whether the replay count is equal to or over n or not (S780). When the replay count is equal to or over n (if S780 is YES), the count management program performs a predetermined process to separate the advertising message from the music data, and only the musical piece is played (S790). Then, the replay count in the count management file is added and the process is ended (S810).

On the other hand, when it is determined that the replay count is under n in S780 (if S780 is NO), the above separation process is not performed and the musical piece combined with the advertising message is played (S800). Then the replay count of the count management file is added and the process is ended (S810).

Accordingly, the user must listen to the musical piece combined with the advertising message till the user listens to the music data n times, but thereafter can listen to the musical piece independently.

Specifically, by execution of the aforementioned count management program, the company can be assured that the general user always listens to the advertising message more than a certain number of times, and as a result, can be assured that more than certain level of advertising effects are expected. On the other hand, the general user can always obtain data which include only a musical piece which the user wants to listen even though having no knowledge for data processing because the advertising message is automatically separated after a predetermined number of listening. Accordingly, use of the advertisement distribution system 1 is promoted, and thus advertising effect of the company is dramatically heightened.

On the other hand, when there is no request for play in S710 (if S710 is NO) and there is a request for a transfer (if S820 is YES), the data for transfer, count management program and count management file are transmitted (S830). However, the data for transfer are locked so that the data cannot be played without an input of a predetermined password explained later.

The data for transfer are music data including the advertising message. Specifically, even if the advertising message is once separated in the aforementioned S790, when the data are transferred, music data including the advertising message prepared aside from the data currently used are transmitted. Furthermore, the count management file is also a file prepared aside from the file currently used, and the file in which a replay count is zero is transmitted.

Accordingly, a user to whom the music data are transferred cannot obtain the musical piece without the advertising message before the user listens to the music data at least n times. Therefore, advertisement of the company cannot be obstructed by a transfer without much thought, and on the contrary, by the transfer, advertising efficiency can be raised.

Furthermore, when it is determined that the data are the transferred data in S730 (if S730 is YES), an input of the aforementioned password is requested to the user (S740). The password is issued to the user for free when the user accesses the service center 3.

When the user enters the correct password (if S750 is YES), the transferred data are unlocked and can be played as normal music data (S760). On the other hand, when there is no input of the password (if S750 is NO), the process is ended.

By setting a password as above, the administrator of the advertisement distribution system 1 can grasp the number of the transfer made by the user on basis of the number of requests for the password, and also gain information of the name of the advertised company, the area where the data are transferred, and the like. Furthermore, by the counting, a fair fee can be calculated for the owner of the musical piece, and as a result, offers of musical pieces can be accepted by the owner. Moreover, the company can become aware of the advertising effects as an actual numerical value by grasping the number of the transfer.

Second Embodiment

In the present example, the advertisement distribution system of the present invention is adapted to the system for distributing emails with an exchange check for money to portable terminals selected by positional information. An overall constitution of the advertisement distribution system of the present embodiment is the same as that of the above first embodiment. Therefore, the description of the system is omitted.

Firstly, a general user accesses the service center 3 and registers a telephone number and an email address of the cellular phone (portable terminal (user terminal)) in advance. The service center 3 transmits distribution information (contents of musical pieces, place and time of distribution, etc.) of music data that the user can obtain for free to the user's email address.

The general user who received the above distribution information at the user terminal 5 heads for the specified distribution place by the specified distribution time if the user wishes to obtain the musical piece.

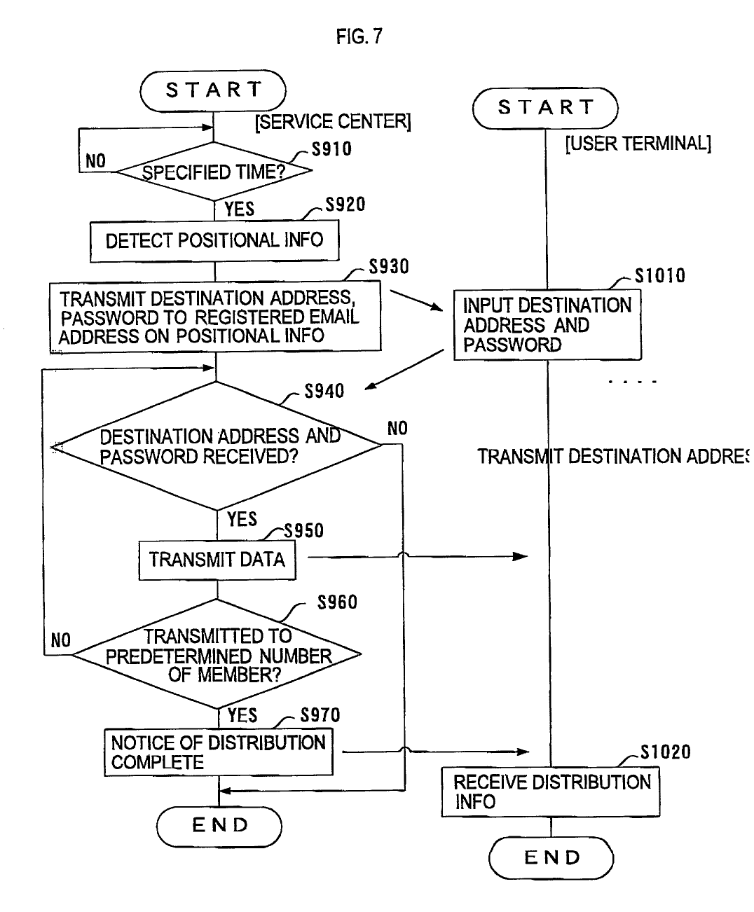

As shown in FIG. 7, when the service center 3 determines that the specified time has come (if S910 is YES), it uses a positional information service utilizing GPSs or PHS stations to detect the positional information of the portable terminal with the aid of the user's telephone number (S920). At this time, telephone numbers of the members who are within a radius of R (m) from a predetermined specific place are extracted. The radius R (m) can be arbitrarily set by the service center 3.

Then, a destination address to be accessed and a proper password for obtaining the music data are transmitted to the email addresses which are correspondent to the extracted members' telephone numbers (S930).

When the user enters the transmitted address and the password from the portable terminal (S1010) and receipt of the information is confirmed (if S940 is YES), the music data are transmitted to the user's portable terminal (S950). The music data are in combination with an advertising message of a sponsor company.

Then, it is determined whether the music data are distributed to a predetermined number of users (S960) and if not, the distribution steps are repeated till the distribution to the predetermined number of users is completed (S940-S960).

When the distribution is completed (if S960 is YES), a notice of distribution complete is transmitted to the users who accessed the destination address thereafter (S970).

The general user receives the music data or the notice of distribution complete (S1020).

The separation process of the music data to be executed thereafter is the same as in the first embodiment. Therefore, an explanation is omitted.

As described above, the advertisement distribution system detects the positional information and distributes music data only to the members who are located in a specific area. That means that it is constituted as a user-participatory email delivery system in which the registered user can join in events only when the user wishes to.

Therefore, it can be said that the user can obtain contents data such as musical pieces or the like by registering only the email address and telephone number without disclosing the name and other private information to the service center 3. Furthermore, since, similar to the case in the first embodiment, the music data are in combination with an advertising message, the needs of the company can be also satisfied.

In this case, in order to exclude specific places such as the users' normal living area, that is, home, office, school, etc. from the places to receive the transmission of the contents data from the service center 3, the system can be configured such that information to identify the specific places (such as the out-of-town telephone exchange number, local telephone exchange number and postal code number) are registered in association with the member's telephone number or email address, and that when it is detected that the member's portable terminal is located in any of such specific places, the contents data are not transmitted to the portable terminal. The system can be available in various scenes such as to collect customers to a department store, to an event, or to a specific area for the purpose of promotion of the local economy.

In the following is described an illustrative case according to the present embodiment.

Illustrative Case

“Today's email is different from the ordinary email advertisement. It seems to provide information on the event of newly released musical piece of the singer A. As instructed in the email, I accessed the specified address from my portable terminal. On the addressed page, it is posted as follows: Shibuya intersection at 2 p.m. on Aug. 3, 2001.

On that date at Shibuya intersection, the lamp of my portable terminal signaling for an incoming call is suddenly flashed at 1:50 p.m., and a destination address and a password are transmitted. The password is only transmitted to the members of the email service who are now located in Shibuya. The first 5,000 members can download the new release. Start time for the application is 2:10 p.m.

At 2 p.m., the singer A appeared on three of the Aurora Visions in Shibuya. A promotional film for the new release to be on sale tomorrow is played twice. This is the first time for the film to be played without any omission. At 2:10 p.m., the members who received the password started to enter the password to their own portable terminal. Free download of the new release for the first 5,000 members has started. The musical piece downloaded at this place specifically includes a message by the singer A. This time, it was planned that the singer A makes a contribution as charity. However, hereafter, company advertisement is added also to the singer A's musical pieces as usual. Then, famous DJs introduce the musical pieces and so it may come up to our expectations on the contrary.

Since new releases can be obtained for free, there is no need to visit the sites offering a pay download. Almost all indies can be downloaded for free, and even in the case of popular singers, there is an event of a free download as above for a new release. Naturally, such information can be obtained only via a portable mail service utilizing the positional information.”

In the above, embodiments of the present invention were described. But the present invention is not limited to the above-mentioned embodiments and can be embodied in various ways within a technical scope of the present invention.

For example, in the above embodiments, the service center 3 administers information on musical pieces and advertisement in its own server. However, it is also possible to constitute the system such that the service center 3 obtains the information on musical pieces and advertisement from other existing servers, and performs the combining process. Furthermore, not only musical pieces but also images and other digital contents can be used as advertising media.

In addition, in the above embodiments, the system is constituted such that upon transfer of data, distribution data with an advertising message provided otherwise are sent to another user. However, it may be appropriate to constitute the system such that a recombining process feature is added to the count management program and the distribution data is again combined with the once-separated advertising message and transferred.

Moreover, the above embodiments show that music data acquired by a general user are transferred to the other's terminal However, the same constitution can be adopted if the terminal is an exclusive player (such as MPS player, etc.).

What is claimed is:

1. An advertisement distribution system comprising
a storage means for storing, as distribution data in a plurality of types, both or one of music data including a specific musical piece combined with an advertising message and image data including a specific image combined with at least one of an advertising image and an advertising message, and
a transmission means for transmitting the type of the distribution data stored in the storage means to a user terminal via a predetermined communication line, and at the request of a user inputted from the user terminal via the communication line, extracting the distribution data selected by the user from the storage means to transmit to the user terminal via the communication line.

2. The advertisement distribution system as set forth in claim 1, wherein said music data or image data are constituted such that said advertising message or advertising image is disposed at least one of just before and after the specific musical piece or specific image, respectively.

3. The advertisement distribution system as set forth in claim 1, wherein said music data or image data are digitized, and constituted such that said advertising message or advertising image overlaps at least one of the first part and the last part of the specific musical piece or specific image, respectively.

4. The advertisement distribution system as set forth in claim 1, wherein said advertising message or advertising image can be separated from said specific musical piece or specific image, respectively.

5. The advertisement distribution system as set forth in claim 4, wherein said advertising message or advertising image is automatically separated from said specific musical piece or specific image after said music data or image data have been played predetermined times.

6. The advertisement distribution system as set forth in claim 5, wherein
when said music data are transferred or copied from said user terminal to another terminal, the music data are transferred or copied with said advertising message combined, or with said specific musical piece unplayable, and
when said image data are transferred or copied from said user terminal to another terminal, the image data are transferred or copied with at least one of said advertising message and advertising image combined, or with said specific image unplayable.

7. The advertisement distribution system as set forth in claim 6, wherein
when said music data or image data are transferred or copied from said user terminal to another terminal, they are locked so that they cannot be played, and
by entering a predetermined password transmitted from the advertisement distribution system on a predetermined condition, the music data or image data are unlocked.

8. The advertisement distribution system as set forth in claim 1 further comprising
a detection means for detecting positional information of said user terminal,
wherein said transmission means transmits the type and an acquisition method of the distribution data to the user terminal detected by the detection means, and then, to the user terminal requesting acquisition of the distribution data according to the acquisition method, transmits the distribution data on a predetermined condition.
